(19) United States
(12) Patent Application Publication
(10) Pub. No.: US 2009/0075142 A1
(43) Pub. Date: Mar. 19, 2009

(54) NANOIMPRINTED ELECTRODES FOR FUEL CELLS

(75) Inventors: Andre D. Taylor, New Haven, CT (US); Brandon D. Lucas, Ypsilanti, MI (US)

Correspondence Address: BROOKS KUSHMAN P.C., 1000 TOWN CENTER, TWENTY-SECOND FLOOR, SOUTHFIELD, MI, 48075, US

(73) Assignee: THE REGENTS OF UNIVERSITY OF MICHIGAN, Ann Arbor, MI (US)

(21) Appl. No.: 12/210,481

(22) Filed: Sep. 15, 2008

Related U.S. Application Data
(60) Provisional application No. 60/993,563, filed on Sep. 13, 2007.

(51) Int. Cl. H01M 8/10; B05D 5/12

(52) U.S. Cl. 429/30; 427/115

(57) ABSTRACT

Nanoimprint lithography (NIL) method to fabricate electrodes with high specific Pt surface areas that can be used in fuel cell devices. The Pt catalyst structures were found to have electrochemical active surface areas (EAS) ranging from 0.8 to 1.5 m²g₋₁ Pt. These NIL catalyst structures include fuel cell membrane electrode assemblies (MEA) that are prepared by directly embossing a Nafion membrane. The features of the mold were transferred to the Nafion® and a thin film of Pt was deposited at a wide angle to form the anode catalyst layer. The resulting MEA yielded a Pt utilization of 15,375 mW mg⁻¹ Pt compared to conventionally prepared MEAs (820 mW mg⁻¹ Pt).

### CROSS-REFERENCE TO RELATED APPLICATIONS

This application claims the benefit of U.S. provisional application Ser. No. 60/993,563 filed Sep. 13, 2007, which is incorporated herein by reference.

### BACKGROUND OF THE INVENTION

1. Field of the Invention

The invention relates to fuel cells, and more particularly to micro-fuel cells and electrodes used therein that are nanoimprinted.

2. Background Art

A fuel cell is an electrochemical conversion device. Generally stated, the cell produces electricity from fuel (on the anode side) and an oxidant (on the cathode side), which react in the presence of an electrolyte. Unlike electrochemical batteries, fuel cells consume reactant, which must be replenished. The fuel cell's electrodes are catalytic and relatively stable.

The catalysis process separates component electrons and protons of the reactant fuel and directs the electrons through a circuit, thus converting them to electrical energy. Typically, the catalyst includes a platinum (Pt) group metal or alloy.

In a hydrogen-oxygen proton exchange membrane fuel cell (PEMFC), a proton-conducting polymer membrane separates the anode and cathode. In such cells, the membrane may serve as an electrolyte. One material that is suitable for electrolytes in a PEMFC design is Nafion®, which serves as a proton conductor. As used herein, the term “Nafion” includes: (i) a polytetrafluoroethylene (PTFE, DuPont's Teflon™)-like backbone, (ii) side chains of —O—CF₂—CF—O—CF₂—CF₂— which connect the molecular backbone to the third region, and (iii) ion clusters consisting of sulfonic acid ions.

The electrodes used in fuel cells are conventionally bipolar plates that are coated with a catalyst like platinum (Pt), or palladium (Pd) for higher efficiency.

### SUMMARY OF THE INVENTION

Against this background, it would be desirable to provide a fuel cell alternative to batteries, especially but not exclusively for portable electronic devices that can be manufactured with efficient utilization of materials and low cost without impairing longevity or efficiency of the manufactured product.

More specifically, to satisfy this need, it would be desirable to deposit a catalytic material on to spin casted films such as Nafion® which is nano patterned.

Further, it would be useful to fabricate electrodes that have non-planar surfaces without impairing the quality of the manufactured component.

It would also be desirable to achieve pattern resolutions beyond those that may be achieved by conventional patterning methods.

Accordingly, the invention relates, in one aspect, to the use of nanoimprint lithography (NIL) to fabricate electrodes with high specific metallic surface areas so as to improve the performance and lower the cost of the electrodes. The disclosed nanoimprint techniques can achieve pattern resolutions beyond the limitations set by light diffraction or beam scattering offered by other conventional techniques. In addition, NIL can be used to pattern nonflat surfaces without the need for planarization.

It would be desirable to use NIL to deposit a catalytic material onto nano patterned Nafion® or alternative (e.g. polyelectrolyte) films, as well as on bulk Nafion® 117 that is available from DuPont. In one example, for the Nafion® 117, a shadow mask was used and a thin film of Pt catalyst was deposited on top of the nanostructures at an oblique angle (e.g. 0-90 off-normal) which created a high surface catalyst area film. This Nafion® film was then incorporated into a membrane electrode assembly (MEA) and evaluated in a fuel cell.

In one aspect, the invention discloses how to fabricate electrodes with Pt nanostructures using a NIL method. The Pt nanostructures were electrochemically active. Another aspect relates to a method of depositing a catalytic material, e.g. Pt. onto Nafion® thin films for use in microelectromechanical systems (MEM) devices that exploit the material properties of an ion-selective membrane. An embossed Nafion® 117 film with Pt deposited on the nanostructures was fabricated into an MEA and was demonstrated to be active. The catalyst layer on the embossed nanostructured Nafion® had a significantly higher Pt utilization than a conventional catalyst layer.

### BRIEF DESCRIPTION OF THE DRAWINGS

FIGS. 1 (fuel cell stack)-2 (fuel cell architecture) are perspective, exploded views of a low temperature proton exchange membrane fuel cell (PEMFC);

FIG. 3 describes an exemplary apparatus and in one illustrative approach, process steps used in one application of nanoimprint lithography to emboss metallic nanoparticles on a substrate;

FIG. 4 is a graphic characterization of electrodes fabricated according to the disclosed process; and

FIG. 5 depicts polarization curves of standard and nanoimprint membrane electrode assemblies.

### DETAILED DESCRIPTION OF THE PREFERRED EMBODIMENT(S)

There are three broad aspects of the invention:

(1) patterning of thin film metal nanoparticles on top of an electrode;

(2) taking these patterns and embossing them onto an ion selective thin film (e.g., Nafion) for micro fuel cell or fuel cell or sensor applications; and

(3) patterning an ion selective film using a nanoimprinting method and depositing the thin film nanoparticles on a bulk film (e.g., Nafion®) to make a fuel cell membrane electrode assembly.

Fabrication of the PEMFC

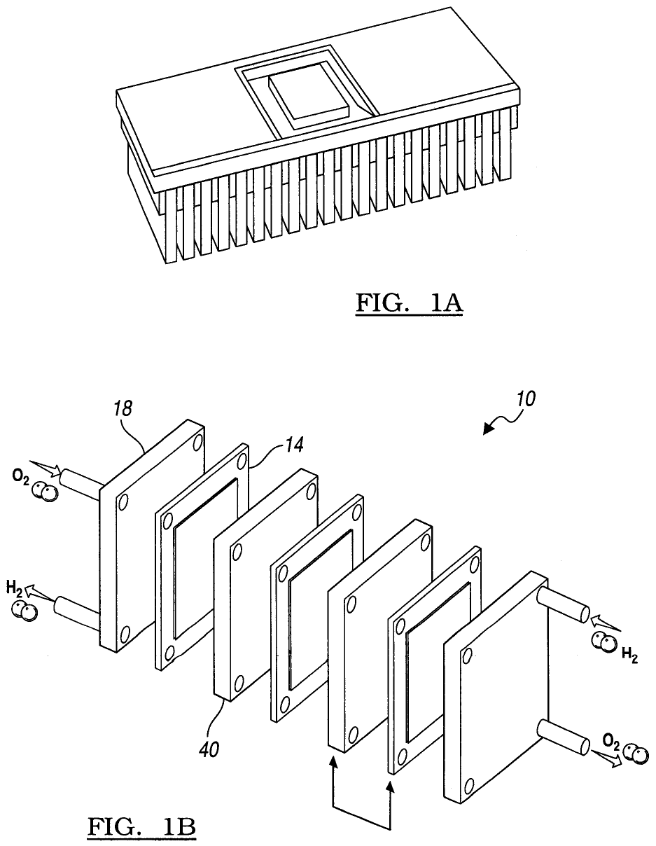

FIGS. 1 and 2 are illustrative embodiments of a proton exchange membrane fuel cell (PEMFC) 10. In FIGS. 1-2, hydrogen is delivered to an anode side 12 of the membrane electrode assembly (MEA) 14, where it is catalytically divided into protons and electrons. The emergent protons travel through preferably, a polymer electrolyte membrane 16 to the cathode, while the electrons travel along an external circuit to the cathode side of the MEA 14, thereby generating an electrical current that serves as an output of the fuel cell.

At the same time, oxygen is delivered to the cathode side 18 of the MEA 14, where oxygen molecules react with the protons that pass through the electrolyte membrane 16 and the electrons arriving through the external circuit to form water molecules.

The membrane 16 thus conducts hydrogen ions (protons) but not electrons. Ideally, the membrane 16 should have minimal resistance to proton flow. In use, the membrane should not allow either gas to pass to the other side of the cell (gas cross over). Also, the membrane must be able to resist the reducing environment at the cathode 18 and the oxidizing environment at the anode 12.

Splitting the hydrogen molecule is enabled with a catalyst 20, like platinum. Often, a platinum catalyst 20 is used to split hydrogen molecules.

As noted earlier, a preferred membrane 16 is Nafion® by DuPont, which is typically used at temperatures at or below 80-90° C. Above that temperature, the Nafion® membrane tends to dry.

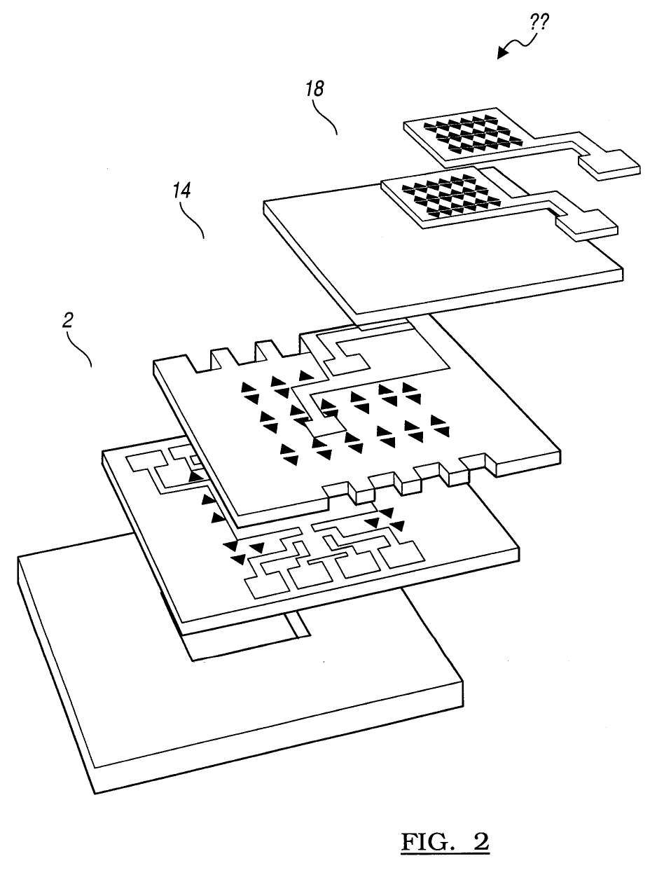

FIG. 3 illustrates the variation of a NIL process for embossing nanometer-scale patterns 22 of metallic nanoparticles 24 on a substrate 26. In that process, a thin layer of imprint resist (thermoplastic polymer 30) is spin coated onto the substrate 26. In one example, the substrate 26 was a Cr/Au layer 32 applied to an oxide-covered Si wafer 34. Topological patterns 22 are defined within a mold 28 that is brought into contact with the coated substrate 26. The mold 28 and substrate 26 are then united under pressure. After heating above a glass transition temperature of the polymer 30, the pattern 22 in the mold 28 is pressed into the melt polymer film 30. Following cooling, the mold 28 is separated from the sample. What remains is the pattern resist 36 on the substrate. A pattern transfer process, such as reactive ion etching may be used to remove polymers from the undesired regions and thus transfer the pattern in the resist 36 to the substrate 26.

Thus on top of the silicon wafer, there is a Cr—Au layer and a polymer; and then the mold comes down and imprints on top of that polymer, compressing the region where the mold is the thickest and leaving the other regions intact where the mold is thin, thereby imprinting the pattern of the mold onto the polymer layer. Reactive ion etching (RIE) etches away the polymer. The thinner compressed regions etch away much faster until they are gone, leaving the noncompressed regions intact. A metal film is then deposited on top of those residual polymer and flat surface layers. The unwanted polymer is then removed. This leaves the pattern in the regions where the polymers are removed and the metal has been deposited. The patterning of metal using a patterned polymer is also called metal lift-off. That makes a desired pattern which in one embodiment is what is depicted schematically as the cubic structures in FIG. 3.

### The Nanoimprint Mold

The one-dimensional SiO₂ grating mold used in one example for electrode fabrication and Nafion embossing is characterized by a 1:1 duty cycle and 700 nm pitch. The NIL technique used permits the simultaneous transfer of nanoscale features to a variety of different substrates, e.g., those having a non-planar topography. Preferably SiO₂ molds are used for nanoimprinting. In one example, the mold had a bar or grating topography with a 700 nm pitch. In another example, a rod mold structure was used in which three parallel rows were separated by a distance of about 500 nm. In another case, a cube mold structure was used with spacing of about 70.4 nm; a periodicity of about 737 nm and a unit distance of about 119 nm. In that example, the height of the cube was about 190 nm.

### The Nanoimprinted Electrodes

The nanoimprinted electrodes 40 were fabricated in one experiment on a single side of a polished P type 4 in. <1 0 0> silicon wafer 34. Following a standard pre-furnace clean, a 200 nm low pressure chemical vapor deposition (LPCVD) oxide 38 was grown on the wafer 34 (FIG. 3, Step 1) to isolate the electrodes 40 from the substrate 26. A 200 nm planar Au film 32 was deposited (Step 2) using an electron beam (e-beam) evaporator (Enerjet Evaporator, pressure <10⁻⁶ Torr) with a 3 nm Ti underlayer (not shown in FIG. 3) serving as an adhesion promoter. The wafers 34 were then cleaved to appropriate sizes for the nanoimprint lithography step.

### Nanoimprint Lithogaphy

In one example, the nanoimprint resist (Micro Resist Technology mr-I 8030; T_{g}=115° C.) 36 was spin cast (250 nm) (Step 3) on to the freshly prepared substrate and baked using a hotplate (140° C.; 5 minutes) to remove residual solvent. The sample was then imprinted (Steps 4-5) using a nanoimprinter (700 psi, 180° C., 5 minutes), cooled to 55° C. and released from the mold 28. An electron beam deposited Cr mask layer was applied to the protruding lines of the surface relief pattern using shadow evaporation at approximately 60° off normal. This step was included to help increase the fidelity of pattern transfer during residual polymer removal, independent of the etch anisotropy and to create a preferred undercut for liftoff processing. The residual polymer layer was removed (Step 6) using (RIE) reactive-ion etching (20 sccm O² 50 W, 20 mT).

The Pt catalyst lines (5-200 nm) were subsequently deposited (Step 7) using e-beam evaporation onto a 3 nm Ti adhesion layer through a shadow mask to produce a well-defined rectangular nanostructured surface. Metal and resist liftoff (Step 7) were accomplished using an acetone soak and gentle mechanical cleaning with a swab was used to remove any residual insoluble complex from the Pt and Au surfaces.

Illustrative electrodes are exemplified by Pt nano-bars (thickness: 50 nm) (Step 8). In one example, the Pt nanoimprinted electrodes comprised bars with a width and pitch of 350 nm, which corresponds to a 700 nm period grating mold. The dimensions of a corresponding single Pt bar were 133 mm×350 nm×50 nm, and a4.5 mm×350 nm×5 nm.

### Spin Cast Nafion® Embossing

Nafion® solutions (5% Aldrich) were spin cast (FIG. 3, Step 3) onto pieces of oxide-covered silicon 34. In one experiment, the thickness of the film was 500 nm and was calibrated at a spin speed of 500 rpm. The molds were pressed into the substrates at 900 psi and 135° C. for 5 min. These conditions yielded the best transfer of mold features to the thin films. The pattern transferred to these features was observed to be uniform.

### Nafion® 117 Embossing

The Nafion® 117 films were cleaned as follows: to remove organic impurities and to obtain the H+ form for use in the PEM fuel cell, the membranes were pretreated by boiling in 50 vol. % HNO₃ and deionized water for 1 hour. The films were then rinsed in boiling deionized (DI) water for 30 minutes, boiled in a 0.5 M H₂SO₄ solution for 30 minutes, and boiled twice in DI water for 30 minutes. The membranes were subsequently stored in DI water until ready for use.

A hydrated Nafion® 117 membrane was placed onto a clean Si substrate and dried using a stream of N₂ to remove any visually observable water droplets from the surface. The mold was then placed directly onto the membrane and inserted into the nanoimprinter chamber. In one example, a pressure of 900 psi was immediately applied to the sample to minimize membrane buckling due to loss of moisture as the chamber temperature was increased to 150° C. The film was held at 150° C. for 5 minutes, then cooled to 55° C. The mold was separated from the membrane and a thin film of Pt (7.5 nm) was deposited onto the protruding lines of the embossed pattern. A shadow mask was used to ensure that the Pt was deposited only on the embossed region, and the film was oriented at an angle from the Pt target to maximize Pt coverage on the peaks and valleys of the embossed (nanostructured) region and prevent a continuous film coverage.

### Electrode Characterization

The catalyst structures (fabricated on Au-covered SiO₂ on silicon) are characterized electrochemically using cyclic voltammetry in a half-cell three electrode system containing 0.5 M H₂SO₄ electrolyte versus a Ag/AgCl reference electrode (Bio Analytic Systems). The electrolyte solutions were prepared from Milli-Q® water and sulfuric acid (Fischer CMOS grade). Before carrying out an experiment, the electrolyte in the three-electrode chemical cell was purged with Argon for 30 minutes. The electrode potential was controlled by a PAR (Prince Applied Research) Model 273 potentiostat which was controlled using CorrWare Electrochemical Experiment Software developed by Scribner Associates, Inc. The counter electrode was a Pt wire attached to a Pt mesh. Potentials were observed versus the Ag/AgCl reference electrode. Before each experiment, the counter and working electrodes were thoroughly rinsed in Milli-QR water.

### Examples of Fuel Cell Testing

Membrane electrode assemblies 14 incorporating the standard electrode and the embossed Nafion® 117 anode side with a Pt thin film 24 were fabricated using E-tek (ELAT v3.1 double side automated) gas diffusion layers (GDLs). The catalyst ink solutions were prepared using a Johnson Matthey Pt/C catalyst (20 wt. % Pt loading). The cathode catalyst layers with Pt loadings of 0.5 mg cm⁻² were prepared using an ink solution consisting of 68% Pt/C, 20% Nafion®, and 12% PTFE by weight. The standard MEA anode consisted of 75% Pt/C and 25% Nafion® with a Pt loading of 0.5 mg cm⁻². The nanoimprinted MEA had a Pt anode loading of 8.0 μg cm⁻² and a standard cathode. The MEAs 14 were fabricated by hot pressing the electrolyte membrane between two GDLs at 135° C. for 5 minutes at a pressure of 10 MPa.

The MEAs were tested in a single fuel cell housing, and were conditioned overnight until a steady state current was achieved at a potential of 0.6 V. The temperature of the fuel cell was 80° C. and the anode and cathode saturators were set at 90° C. which yield reactant gases with 100% relative humidity. The flow rates of the humidified hydrogen and oxygen were held constant at 100 sccm using mass flow controllers.

### Experimental Results

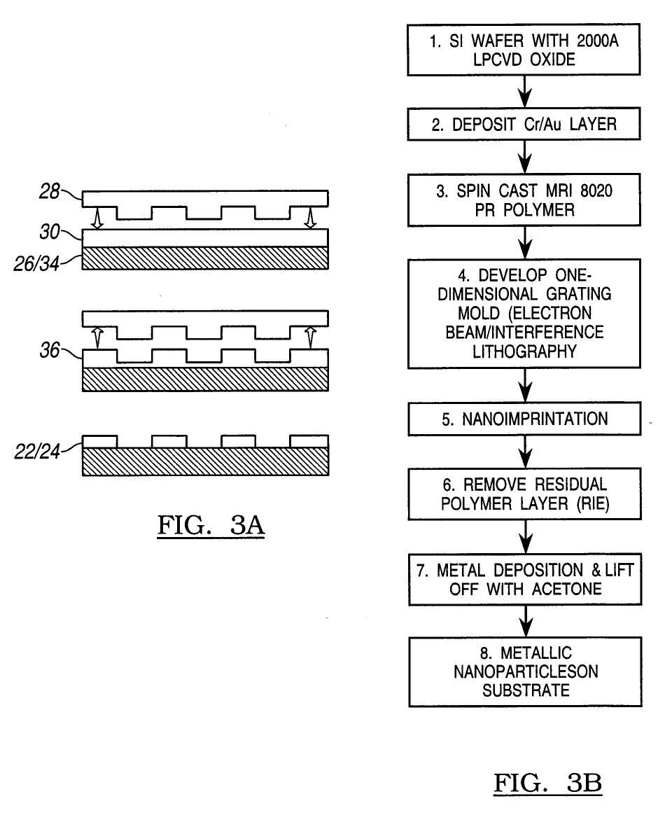

A characteristic voltammogram for the nanoimprinted electrode on SiO₂ is presented in FIG. 4, which represents one of the first steps in testing a new material or a catalyst to see if it is useful as a fuel cell electro catalyst. The voltammogram shows certain electrochemical characteristics of the electrode made using the nanoimprinted method. Consider the peaks below the zero and the top and bottom peaks. In this example, there are 3 at the bottom and 3 at the top—they are the regions where hydrogen absorption and desorption occur at a given potential.

This shows that the platinum metal is active and is indeed a fuel cell catalyst in the hydrogen absorption and desorption regions occur on these metallic particles. The features are typical of polycrystalline Pt.

The thickness of the Pt layer was 50 nm, based on on-line monitoring using a frequency-shift measurement from a resonating crystal. The hydrogen desorption region was integrated to determine the coulombic charge (corrected for the double-layer capacitance of the Pt and Au/Ti support) for each electrode and yielded an electro-chemical active surface (EAS) area of 1.5 m²g⁻¹ Pt.

Such EAS values are higher than those for micro-fuel cell electrodes previously reported. Previous electrodes were prepared using standard micromachining methods and typically had EAS areas of ˜0.3 m² g⁻¹ Pt. These EAS areas are lower than those for typical fuel cell catalysts which range from 65 to 100 m² g⁻¹ (e.g. 20 wt. % Pt/Vulcan XC72).

Imprinting nanostructures directly onto Nafion® thin films produce features that in one embodiment possess a 700 nm period. The surface edges of the embossed film appear to be rounded, which suggests that the films relaxed (and/or expanded) after the compression step. This may be due to the films being embossed immediately after casting without curing. Consistent color diffraction in the imprinted region suggests that the rest of the film was not compromised from this process.

Thus, the embossing of nanostructures onto Nafion® thin films holds promise for a variety of new micro-fuel cell and sensor designs. In addition, micro-fluidic devices that exploit the proton selectivity of Nafion® for reactions and/or separations might now be enabled.

Previous attempts to emboss Nafion® 117 focused on casting a uniform layer of nanoimprint resist on the surface of the membranes. This proved to be difficult due to buckling of the membrane, as it was either dried or absorbed solvent from the resist layer. In contrast, the inventive direct embossing of Nafion™ has the advantage of controlled surface modification without chemical contamination. Previously, it was observed that chemicals used in modem micromachining processes (e.g. photoresist, photoresist developer, solvent, etc.) can negatively impact the performance of an MEA.

Since lift-off and post-chemical treatment were not required for this process, a shadow mask was created to selectively deposit Pt over the embossed nanostructured features.

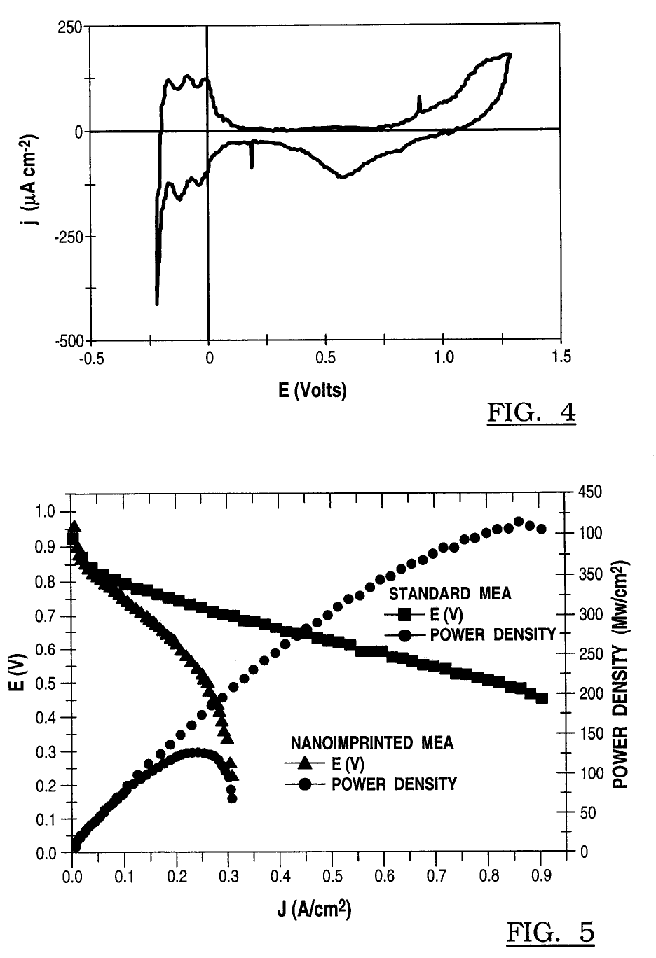

The membrane was fabricated into an MEA and the performance was compared to an MEA prepared using conventional materials. The polarization curves are illustrated in FIG. 5. In that figure, the nanoimprinted membrane electrode assembly is compared to the standard membrane electrode assembly. In the standard membrane electrode assembly, the peak power density (the second Y axis for the standard membrane electrode assembly) is about 410 mW cm⁻². The nanoimprinted membrane electrode assembly has a peak power density of about 123 mW cm⁻². It may appear that the standard is better than a nanoimprinted MEA. But in electrochemistry and for fuel cells, the observer normalizes the data by the amount of catalyst that is being used in the electrode. So, for example, the standard MEA has a catalyst loading of 0.5 mg of Pt cm⁻². The nanoimprinted MEA has on the order of micrograms of Pt cm⁻² Thus, the Pt utilization for the nanoimprinted membrane electrode assembly is several orders of magnitude higher than the Pt utilization of the standard MEA. Although the peak power density of the nanoimprinted MEA was 123 mW cm⁻², which was lower than that for the conventionally prepared MEA (410 mW cm⁻²), the Pt utilization for the former was 15,375 mW mg⁻¹ Pt compared to 820 mW mg⁻¹ Pt for the conventional electrode. These values were determined by dividing the peak power density by the Pt loadings for the anode (conventional MEA, 0.5 mg cm¹²; MEA with nanoimprinted electrode, 8 μg cm⁻²).

The added areas from the Pt on the sidewalls of the nanostructures could contribute to increased performance over a planar surface. For instance for one structure studied, the available added surface area was twice the amount of the planar surface.

The improvement of a Pt film deposited onto Nafion® achieved with this method is also consistent with improvements demonstrated by Cha et al. In this work, MEAs with sputtered films of Pt (deposited on top of the catalyst layer) shower an increase in performance compared to standard MEAs. The conclusion was that a higher concentration of Pt either near the GDL or Nafion® layers increased performance of the catalyst layer.

In summary, control of catalyst particle size and orientation through the use of NIL could be a useful way to construct model catalysts. In addition, with the precise control of thin film thickness using micromachining facilities coupled with smaller feature sizes available from NIL, the exploitation of unique material properties available at the nanoscale could be further realized.

Here is a list of reference numerals and the components to which they refer:

| Ref. No. | Component |
|---|---|
| 10 | Proton exchange membrane fuel cell (PEMFC) |
| 12 | Anode |
| 14 | Membrane electrode assembly (MEA) |
| 16 | Electrolyte membrane |
| 18 | Cathode |
| 20 | Catalyst |
| 22 | Patterns (mold) |
| 24 | Nanoparticles |
| 26 | Substrate |
| 28 | Mold |
| 30 | Polymer (e.g. Nafion ®) |
| 32 | Metallic layer (e.g. Cr/Au) |
| 34 | Wafer (e.g. Si) |
| 36 | Pattern resist (substrate) |
| 38 | Oxide layer |
| 40 | Metal electrode (e.g. Pt) |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A nanoimprint lithography method for making an electrode, the electrode having a high specific metallic surface area, the electrode having a surface that is characterized by a topography, the method comprising:
preparing a substrate comprising a polymer;
imprinting a nanostructured pattern into the polymer;
depositing a catalytic material onto the nanostructured pattern to form a modified substrate; and
incorporating the modified substrate into a membrane electrode assembly.

2. A nanoimprint lithography method for making an electrode, the method comprising the steps of:
(1) preparing a substrate;
(2) depositing a conductive metallic layer thereupon;
(3) spin casting a polymer on the metallic layer;
(4) developing a mold;
(5) nanoimprinting the polymer with the mold;
(6) removing a residual polymer layer; and
(7) depositing catalytic nanoparticles into a specific pattern.

3. The method of claim 2 wherein the substrate is selected from the group consisting of a silicon wafer and a glass wafer.

4. The method of claim 2 further comprising an oxide layer that is about 2,000 angstroms thick that is deposited by chemical vapor deposition.

5. The method of claim 2 wherein the metallic deposition step comprises depositing layers of Cr and Au, such that the Cr layer is adjacent to the substrate.

6. The method of claim 2 wherein the spin casting step comprises casting a polymer selected from the group consisting of MRI and other suitable polymers.

7. The method of claim 2, wherein step (4) comprises a mold having a 700 nm period.

8. The method of claim 2, wherein step (7) further comprises deploying bars of metallic nanoparticles, the bars having a width and pitch of about 350 nm.

9. The method of claim 1, wherein the topography is non-planar.

10. A hydrogen-oxygen proton exchange membrane fuel cell (PEMFC) comprising:
a nanoimprinted anode having a feature dimension less than 1 micron;
a nanoimprinted cathode having a feature dimension less than 1 micron;
a nanoimprinted electrolyte with catalytic nanoparticles on its surface having a unit of dimension less than 1 micron, the electrolyte further comprising
a proton-conducting polymer membrane that separates the anode and cathode.

11. The fuel cell of claim 10 wherein the electrolyte comprises Nafion®.

12. The fuel cell of claim 10, wherein the fuel cell has a nanoimprinted electrode including polycrystalline Pt particles with an electro-chemical active surface area of at least 1.5 m²g⁻¹ of Pt.

13. The fuel cell of claim 12, having a Pt utilization of over 15,000 mWmg⁻¹ of Pt.

14. The fuel cell of claim 10 comprising a catalyst layer having a thickness of about 7.5 nm.

15. The fuel cell of claim 10 wherein the electrolyte has a thickness of about 0.5 microns.

16. The fuel cell of claim 10 further including a gas diffusion layer having a thickness of about 2 microns.

17. The fuel cell of claim 10 having a power density on a per volume basis that is at least 123 mW/cm².

18. The fuel cell of claim 10 wherein the electrolyte has a thickness of about 175 microns.

19. The fuel cell of claim 10, wherein the fuel cell serves as a sensor.
